(19) United States
(12) Patent Application Publication
(10) Pub. No.: US 2009/0216720 A1
(43) Pub. Date: Aug. 27, 2009

(54) METHOD AND SYSTEM FOR PROVIDING ACCURATE LOCATION SERVICE FOR INTERNET APPLICATIONS

(75) Inventors: Christopher Piche, West Vancouver (CA); Shahadat Khan, Burnaby (CA); Lars-Olof Burchard, Vancouver (CA)

Correspondence Address: FASKEN MARTINEAU DUMOULIN, LLP, 2900 - 550 Burrard Street, VANCOUVER, BC, V6C 0A3, CA

(73) Assignee: EYEBALL NETWORKS INC., West Vancouver, BC (CA)

(21) Appl. No.: 12/067,167

(22) PCT Filed: Sep. 18, 2006
(86) PCT No.: PCT/CA2006/001538

§ 371 Date: Oct. 9, 2008

Related U.S. Application Data
(60) Provisional application No. 60/717,238, filed on Sep. 16, 2005.

(51) Int. Cl. G06F 17/30

(52) U.S. Cl. 707/3; 707/200; 707/E17.044; 707/E17.014

(57) ABSTRACT

A method and system for providing location information is provided wherein the sender of a message sends a location ID with the message, after obtaining the location ID from a location server. The location ID includes the location information relating to the sender and the sender's IP address. On receipt of the location ID, the message recipient sends it to a location server, which responds with the location information relating to the sender.

The application claims the benefit of U.S. Provisional Patent Application No. 60/717,238 filed Sep. 16, 2005, which is hereby incorporated by reference.

### FIELD OF THE INVENTION

The invention relates to locating users of a network, and more particularly to accurately determining the geographic location of users of a voice-over-IP (VoIP) network.

### BACKGROUND OF THE INVENTION

Voice-over-IP (VoIP) is the routing of voice conversations over the Internet or through any other EP-based network. VoIP is a substitute for traditional telephone service offered by public switched telephone networks (PSTN).

Determining the location of a caller in a VoIP network is important in many different applications. For example, in case of emergencies (such as 911 calls), it is essential the location of the caller be determined easily. Other situations where such a determination is useful include the provision of location-based services, e.g., finding a hotel or redirecting a caller to a suitable server. Additionally, to determine if a call in a VoIP network is legitimate or a potential spam call it is helpful to determine whether the call comes from a location known to the callee or from an area where the user is unlikely to receive calls. For example, a call received at 3 AM at a home in New York from somewhere in Asia has a higher chance of being unsolicited (unless the callee is also from Asia) than a local call.

Locating the geographic location using an IP addresses, based on static information such as institution, server providers, end users, etc. has already been implemented in various ways and by various service providers. One of the purposes of such EP address location is to redirect clients to servers closer to their location, e.g. for content distribution networks. To obtain the geographical position of a computer, services are available that upon entering an IP address return the approximate location of the IP address (for example see GeoBytes at http://www.geobytes.com/IpLocator.htm). However, this location may not be reliable, as such services do not accommodate for tunneling, proxy usage or other methods to disguise the origin of a message. For example, if a proxy is used to send a message over a network, this message will have the IP address of the proxy instead of the original sender of the message.

Similar difficulties arise in the case of IP addresses assigned to large ISP networks. These addresses are often freely assigned to users and may not even allow the determination of the original country of an IP packet (see MaxMind at http://www.maxmind.com/app/city_accuracy). Therefore, an IP address cannot be used to detect the geographic location of a VoIP caller with confidence.

Location-based services are also available in wireless networks. However, in contrast to the model according to the invention herein, in wireless networks, location information cannot be accessed on network layers above layer two. Instead, usually only the providers of a wireless network (e.g. a cell phone network), use the location (e.g., to provide the cell phone users with information about his/her environment such as nearby hotels or restaurants).

### SUMMARY OF THE INVENTION

In traditional public switched telephone network (PSTN) systems, the source of a call can be tracked to deliver location services (as required for 911 emergency calling). However, for voice calls using the Internet, such as VoIP, currently it is not possible to identify the location of a caller. The method and system according to the invention presents a way to address this deficiency using a network location service. The area of application of the location service focused in this document is IP telephony, such as VoIP, however, the location service can be applied in other scenarios as well.

A method for receiver-based determination and validation of the geographical location of a sender in a computer network is provided, including the following phases and steps:
Phase 1: Location Registration by Service Provider
   This phase works in 2 steps:
R1. Client C1 obtains an IP address from a border device BD; and
R2. Border device BD identifies the customer device or line using layer 1 and 2 information, and records the IP address via location mapping into ISP's location database LDB.
Phase 2: Using Location Information for Internet Applications
This phase works in 4 steps:
U1. Client C1 requests a location ID from a location server LS;
U2. Location server LS queries the ISP database for the IP-location mapping of C1's IP address, generates a unique location ID for this request and IP address and returns it to Client C1;
U3. Client C1 adds the location ID to any desired message (such as call invitations) to C2; and
U4. Client C2 uses the location ID together with the source IP address of the received message to query the location server for the actual location associated with the location ID. The location server queries the database LDB and sends C1's location information to C2.

An architecture for implementing the location service is provided, including the following components:
1. Border devices on layers 1 and 2, which provide location information about connected endpoints to location servers;
2. Location servers with access to layer 1 and 2 related information about the location of network endpoints and assigned IP addresses, which generate location IDs and provide location information upon reception of valid location IDs; and
3. Client applications capable of discovering the nearest location service, for example by using time-to-live (TTL) equal to one (1) or Dynamic Host Configuration Protocol (DHCP), registering with a location service, and—given a location ID—querying the responsible location service for the origin of an incoming message.

In the framework according to the invention described herein, a location ID is an integral part of application layer messages. Therefore, these location IDs are not stripped or modified by proxies. Furthermore, the cryptographic measures used to generate location IDs cannot be manipulated in the same manner as IP addresses, which are simply replaced if a proxy or NAT device is traversed.

A method of registering a location is provided, including (a) obtaining, from a client, an IP address from a border device; and identifying, by the border device, the location of the client using the client's layer 1 or 2 information, and recording the IP address and location to a location database. The client's layer 1 or 2 information may include an access device or line, which is used to identify a customer account, which in turn is used to identify the location of the client for recordation to said location database. The location may be a street address or a latitude and longitude.

A method of determining the location of a first client by a second client, is provided, including: (a) the first client requesting a location ID from a location server; (b) the location server querying a location database for an IP address and the location of the first client, and generating a location ID for the first client; (c) the location server returning the location ID to the first client; (d) the first client adding the location ID to a message for the second client; (d) the second client, on receipt of the message, providing the location ID and the IP address to the location server; and (e) the location server querying the location database using the location ID, and on receipt of location information from the location database, sending the location information to the second client. The location ID may have an expiry period, and may be encrypted via hashing. The location may be a street address or a latitude and longitude.

A system for providing location information within a network is provided, comprising: a border device, the border device assigning an IP address to a first client and identifying a location of the first client; a location server, the location server generating a location ID for the first client, and providing location information on receipt of the location ID; a second client, the second client in receipt of the location ID in a message from the first client; and a location database accessible by the location server and the border device, the location database storing the IP address and the location in association with the first client; the location database responding with the location to a query from the second client with the location ID. The border device may identify the location of the first client by the client's layer 1 or 2 information and the location ID may include the location and said IP address.

A network message from a first client to a second client is provided, including a location ID containing an IP address of the first client. The location ID may be a header of the network message. The message may be an SIP message, and the location ID may be encrypted using a hash function.

A method of providing a location of a first client to a second client is provided, including: (a) obtaining, from the first client, an IP address from a border device; (b) identifying, by the border device, the location of the first client using the first client's layer 1 or 2 information, and recording the IP address and the location to a location database; (c) the first client requesting a location ID from a location server; the location server querying the location database for an IP address and a location of the first client, and generating a unique location ID for the first client; (e) said location server returning the location ID to the first client; (f) the first client adding said location ID to a message for the second client; (g) the second client, on receipt of the message, providing the location ID and the IP address to the location server; and (h) the location server querying the location database using the location ID, and on receipt of location information from the location database, sending the location information to the second client.

### BRIEF DESCRIPTION OF THE DRAWINGS

FIG. 1 is an overview of a preferred embodiment of the process by which callers are registered with the location service according to the invention; and

FIG. 2 is an overview of a preferred embodiment of the process by which the location information is used according to the invention.

### DETAILED DESCRIPTION OF THE INVENTION

In order to locate callers, a location service is introduced to Internet service provider (ISP) networks: in these networks, border devices (devices at the border of a service provider network which connect directly to subscribers' devices) on layers 1 and 2 (the physical and network access layers, which are lower than layer 3, the IP layer) add location information to a global ISP database when new access devices (such as cable modems) obtain IP addresses. Based on the IP address and the related location information in the global ISP database, the location service, through location servers, generates unique location IDs for each caller to be sent with call related messages.

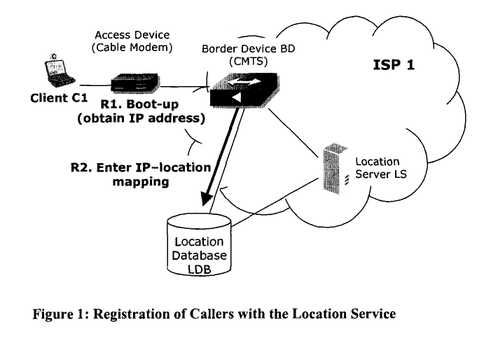

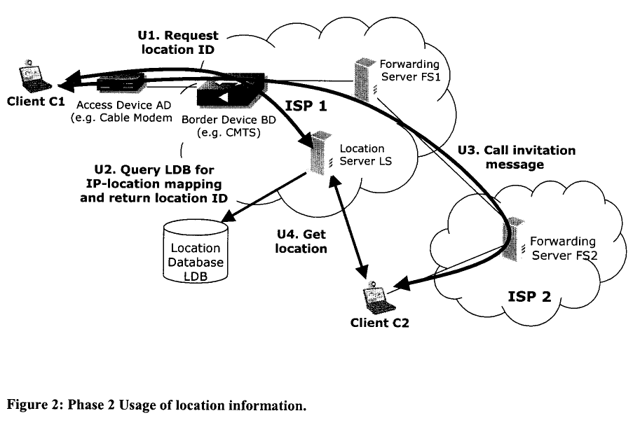

FIGS. 1 and 2 illustrate a general method for enabling location service for Internet applications using a cable-based ISP as an example. Digital Subscriber Line (xDSL) and T1 services are also able to identify a customer based on layer 1 and 2 information such as the access device and/or line. For wireless services, similar methods to track devices on layers 1 and 2 exist, for example based on triangulation.

The method according to the invention works in two phases as follows:

### Phase 1: Location Registration by Service Provider (FIG. 1)

This phase works in 2 steps:
R1. Client C1, using a customer device or line, obtains an IP address from border device BD.
R2. Border device BD identifies the customer device or line using layer 1 and 2 information, and records the IP address and location of client C1 by location mapping into ISP's location database LDB.

### Phase 2: Using Location Information for Internet Applications (FIG. 2)

This phase works in 4 steps:
U1. Client C1 requests a location ID from a location server LS.
U2. Location server LS queries the ISP's location database LDB for the IP-location mapping of C1's IP address, generates a unique location ID for this request and IP address and returns the location ID to Client C1.
U3. Client C1 adds the location ID to any desired message (such as call invitations) to C2.
U4. Client C2 uses the location ID together with the source IP address of the received message to query the location service for the actual location associated with the location ID. The location server queries the database LDB and sends C1's location information to C2.

The location information provided by the method can include a variety of information, for example, longitude and latitude, or a street address. The accuracy of the location information provided is determined by the accuracy of the information available from the underlying layer 1 and 2 border devices. In most cases, e.g. for emergency purposes (911 calls), it is sufficient to know the street address of the call source, which can be provided when using the location of the border device. However, the location service can support arbitrary granularity for the location if such is available from the border devices.

Step R2 allows the location registration to work properly. Here the border device BD uses layer 1 or 2 (physical or network access layer) information such as cable modem ID, Data Over Cable Service Interface Specification (DOCSIS) service ID (for cable ISPs), T1 or DSL modem ID, and phone line ID to identify the customer account. Since the service provider knows the physical location of the customer, such as street address (of the physical line) on file, it can then map the access device or line ID to the location information.

Phase 1 can be triggered when customer device is booted up for the first time, and every time thereafter when it refreshes its IP address.

The Location ID received in step U1 and U2 may use an expiry period to force regular refreshing to ensure that client C1 is not using stale information.

Application examples for the location service include, but are not limited to:
1. Supporting callees in making a decision as to whether a received message is authentic or not. For example, when end-to-end authentication mechanisms are not available or do not provide enough information to identify a caller and its intentions, the knowledge about the location of the caller may be helpful. A particular application is the identification of call sources in VoIP calls to detect unsolicited calls. Using this geographic information, for example, a call with an origin in a different part of the world may be rejected by default. This may also be used to implement a rule based call filtering mechanism with rules such as “do not ring the phone if a call comes from outside Canada or India between midnight and 6 in the morning”.
2. Providing a reliable and convenient way to locate call sources in emergency scenarios (e.g. 911 caller location).
3. Providing a foundation for various location-based services, for example, finding hotels, restaurants, etc. in the vicinity of callers.
4. Locate and identify customers of on-line shops for fraud prevention and other purposes.

The location server is a conventional server (and can be implemented as software) and can be located anywhere in the network of the ISP. For example, location servers can be integrated into the border devices. It is also conceivable to run the location service in various locations across a single ISP network for redundancy and load-balancing purposes.

### Components

The preferred components for implementing a location service as outlined above are (as seen in FIGS. 1 and 2):
1. Border devices on layer 1 and 2, which provide location information about the connected endpoints to the location servers.
2. Location servers with access to layer 1 and 2 related information about the location of access devices and assigned IP addresses, which generate location IDs and provide location information upon reception of a valid location ID.
3. Client applications capable of discovering the nearest location service, registering with a location service, and—given a location ID—querying the responsible location service for the origin of an incoming message.
4. A location database storing the location information of registered clients together with their current IP address.

### IMPLEMENTATION EXAMPLES

For a message to reach its destination, it should retain its location ID parameter throughout any intermediate processing step applied to the message. Furthermore, enhancing the application layer protocols affects, at most, the software components involved. In contrast, changes to a layer lower than layer 3 also affect the network hardware. Therefore, it is desirable to add the parameter to application layer protocols such as Hypertext Transfer Protocol (HTTP) or Session Initiation Protocol (SIP) (see GeoBytes. http://www.geobytes.com/IpLocator.htm) instead of IP or lower layer protocols, which are usually translated several times on the way from sender to receiver. In those text-based protocols, it is useful to add an additional parameter, as the default behavior by network elements not capable of interpreting such parameters is to ignore them. The following implementation examples assume using such a text-based protocol.

### Example 1

### Encoding of the Location Parameters in Network Protocols

The actual encoding of the location ID into a network message depends very much on the protocol used. For example, text-based application layer protocols such as HTTP and SIP provide a flexible framework for header extensions that can be used to encode the location ID. In the following, the usage of an additional header field x-location-id is described. The header field is added to any message of the protocol to be enhanced with location service functionality and contains the location ID obtained from the location service:

x-location-id: bdec38349@location.eyeball.com

The location ID in the example shown above consists of an ID component (bdec38249) and an address component (location.eyeball.com). The address denotes the location service that issued the ID, and provides means for the callee to contact the location server. The location ID is used to uniquely identify the caller in the location service and contains the caller IP address in an encrypted form in order to prevent manipulation. As IP addresses can be contained in each location ID string, the callee does not need the source IP address of the message. The length of the location ID string and the way it is computed depends on the actual location service implementation. The implementation must assure that sufficient information is contained to uniquely identify a registered caller.

To prevent modification by intermediate entities or the forging of location IDs, cryptography (such as hashing) is preferably used to ensure integrity of location IDs. In particular, it is possible to generate location IDs using a cryptographic hash of the location parameters. The location service receiving a location ID retrieves the location information stored for the corresponding client C1 and returns this to the requesting client C2. Location information can be indicated in various ways, for example, using longitude and latitude together with a human readable location description such as follows: 49 16 N, 123 07 W, Vancouver, BC, Canada. The actual information contained in the response from the location service depends on the particular application and may vary.

### Example 2

### Using Location Information to Prevent SPAM over IP Telephony (SPIT)

As are email systems, VoIP systems are in danger of being targets for SPAM. To prevent SPAM in such an environment, also known as SPIT, the location service can be used to determine whether in incoming call originates from a suspicious location, i.e., a region known to be a source of unsolicited bulk calls. The location service in this case can be used to filter call invitations based on the geographical region of the caller. The actual policy enforced in a VoIP network may exclude certain regions and unknown origins completely from the network or perform additional checks on those calls before forwarding them to the destination. Furthermore, clients receiving calls may also query the location service and provide the location information to a call recipient in addition to a caller ID.

Although the particular preferred embodiments of the invention have been disclosed in detail for illustrative purposes, it will be recognized that variations or modifications of the disclosed apparatus lie within the scope of the present invention. The system and methods described herein could be recorded on a computer readable medium as a series of instructions for execution by one or more computers. Alternatively, the system and method described herein could be a recorded on a computer program product, for execution by a computer. Also, the methods and system described herein could be embodied as a carrier wave embodying a computer data signal representing sequences of statements and instructions which, when executed by a processor cause the processor to perform the method described herein.

I claim:

1. A method of registering a location comprising:
(a) obtaining, from a client, an IP address from a border device; and
(b) identifying, by said border device, the location of said client using said client's layer 1 or 2 information, and recording said IP address and location to a location database.

2. The method of claim 1 wherein said client's layer 1 or 2 information includes an access device or line.

3. The method of claim 2 wherein said access device or line is used to identify a customer account.

4. The method of claim 3 wherein said customer account is used to identify the location of said client for recordation to said location database.

5. The method of claim 4 wherein said location is a street address.

6. The method of claim 4 wherein said location is a latitude and longitude.

7. A method of determining the location of a first client by a second client, comprising:
(a) the first client requesting a location ID from a location server;
(b) said location server querying a location database for an IP address and the location of said first client, and generating a location ID for said first client;
(c) said location server returning said location ID to said first client;
(d) said first client adding said location ID to a message for the second client;
(d) the second client, on receipt of said message, providing said location ID and said IP address to said location server; and
(e) said location server querying said location database using said location ID, and on receipt of location information from said location database, sending said location information to the second client.

8. The method of claim 7 wherein said location ID has an expiry period.

9. The method of claim 8 wherein said location ID is encrypted.

10. The method of claim 9 wherein said location ID is encrypted via hashing.

11. The method of claim 7 wherein said location is a street address.

12. The method of claim 7 wherein said location is a latitude and longitude.

13. A system for providing location information within a network, comprising:
(a) a border device, said border device assigning an IP address to a first client and identifying a location of said first client;
(b) a location server, said location server generating a location ID for said first client, and providing location information on receipt of said location ID;
(c) a second client, said second client in receipt of said location ID in a message from said first client; and
(d) a location database accessible by said location server and said border device, said location database storing said IP address and said location in association with said first client; said location database responding with said location to a query from said second client with said location ID.

14. The system of claim 13 wherein said border device identifies said location of said first client by said client's layer 1 or 2 information.

15. The system of claim 14 wherein said location ID includes said location and said IP address.

16. A network message from a first client to a second client, comprising:
(a) a location ID.

17. The network message of claim 16 wherein said location ID contains an IP address of said first client.

18. The network message of claim 17 wherein said location ID is a header of said network message.

19. The network message of claim 18 wherein said message is an SIP message.

20. The network message of claim 19 wherein said location ID is encrypted.

21. The network message of claim 20 wherein said location ID is encrypted using a hash function.

22. A method of providing a location of a first client to a second client, comprising:
(a) obtaining, from said first client, an IP address from a border device;
(b) identifying, by said border device, said location of said first client using said first client's layer 1 or 2 information, and recording said IP address and said location to a location database;
(c) said first client requesting a location ID from a location server;
(d) said location server querying said location database for an IP address and a location of said first client, and generating a unique location ID for said first client;
(e) said location server returning said location ID to said first client;
(f) said first client adding said location ID to a message for the second client;
(g) the second client, on receipt of said message, providing said location ID and said IP address to said location server; and
(h) said location server querying said location database using said location ID, and on receipt of location information from said location database, sending said location information to the second client.
